(19) United States
(12) Patent Application Publication
(10) Pub. No.: US 2026/0206744 A1
(43) Pub. Date: Jul. 23, 2026

(54) COMPOSITION IN THE FORM OF A MICROEMULSION COMPRISING BIFENTHRIN

(71) Applicant: SURCOS IMPACT SÁRL, Mamer (LU)

(72) Inventor: Félix GALÁN ROMANO, Mamer (LU)

(73) Assignee: SURCOS IMPACT SÁRL, Mamer (LU)

(21) Appl. No.: 19/140,795

(22) PCT Filed: Dec. 20, 2023
(86) PCT No.: PCT/IB2023/063051

§ 371 Date: Jun. 18, 2025

Related U.S. Application Data
(60) Provisional application No. 63/434,756, filed on Dec. 22, 2022.

(51) Int. Cl. A01N 25/04; A01N 47/40; A01N 51/00; A01N 53/00; A01N 57/16; A01P 7/04

(52) U.S. Cl. CPC A01N 25/04; A01N 47/40; A01N 51/00; A01N 53/00; A01N 57/16; A01P 7/04

(57) ABSTRACT

The present disclosure provides agronomically useful insecticidal compositions. In particular, the disclosure describes bifenthrin compositions in the form of microemulsions, as well as methods for controlling harmful insects comprising the use of said compositions. The disclosure also contemplates compositions comprising bifenthrin in combination with other insecticidal active ingredients.

### FIELD OF THE INVENTION

The present invention is related to the provision of agronomically useful insecticidal compositions. In particular, the invention is related to bifenthrin compositions in the form of microemulsions.

### BACKGROUND OF THE INVENTION

In recent years, it has been a common trend in the field of agriculture to develop new compositions which are able to decrease the amount of chemical pesticides applied to crops without compromising the effectiveness thereof. This trend is mainly due to the continuing concern about the environmental effects such pesticides might have. Therefore, by achieving more efficient formulations, the actual dosage of the active ingredients of the compositions may be reduced, thus reducing the potential environmental impact agronomical activities may exhibit, while maintaining the performance of the pesticidal effect on the crops.

In this regard, the development of compositions in the form of microemulsions has proven effective in achieving a high efficiency for the application of certain pesticides. For instance, patent applications WO2019215483A1, WO2021224670A1 and WO2022023805A1 describe microemulsions comprising a series of herbicides, in each case highlighting an improved efficiency when comparing the disclosed compositions to known commercially available products.

However, even though formulating agrochemical compositions in the form of microemulsions may be useful to obtain high efficiencies, the use of such dosage forms in commercial products has so far been significantly limited. This is mostly due to the fact that preparing microemulsions which are physicochemically stable both during storage and application is difficult, often resulting in compositions with a subpar stability.

Bifenthrin, CAS No. 82657-04-3, or rel-(2-Methyl[1,1′-biphenyl]-3-yl)methyl (1R,3R)-3-[(1Z)-2-chloro-3,3,3-trifluoroprop-1-en-1-yl]-2,2-dimethylcyclopropane-1-carboxylate (IUPAC name) is an insecticide belonging to the family of pyrethroids. It is a neurotoxic compound that binds to voltage-gated sodium channel, nullifying the cell's ability to restore its action potential. It is widely known in the art, and there are several commercial products comprising it as the active ingredient, although generally in the form of emulsifiable concentrates (EC) or suspension concentrates (SC).

The use of bifenthrin as a microemulsion has been described in the state of the art. For instance, patent application CN 101984808 A describes a bifenthrin microemulsion comprising 4% bifenthrin, while patent application CN 104872114 A describes a bifenthrin microemulsion comprising 10% bifenthrin.

U.S. Pat. No. 6,251,415 B1 describes a mixture of solvents which is capable of dissolving certain insecticides, in particular bifenthrin, wherein the obtained solution may then be used to prepare a stable microemulsion. It teaches the preparation of a microemulsion comprising 0.025% bifenthrin.

U.S. Pat. No. 9,433,207 B2 describes non-ionic aggregates comprising a water-insoluble active ingredient, a non-ionic surfactant system, and water. It mentions that the aggregates may be in the form of microemulsions but does not provide specifics as to the form adopted by the bifenthrin aggregates disclosed therein.

However, there is a constant need of providing new compositions of pesticides which may allow a reduced dosage of the active ingredient, in particular, for widely known compounds such as bifenthrin.

### SUMMARY OF THE INVENTION

It is an aspect of the present invention to provide an agricultural composition comprising bifenthrin, cyclohexanone, calcium phenyl sulfonate, castor oil ethoxylate, tristyrylphenol ethoxylate, fatty acid methyl esters (FAME), a polyalkylene oxide block copolymer, and water. Preferably, the polyalkylene oxide block copolymer is an ethylene oxide/propylene oxide (EO/PO) block copolymer.

In an embodiment of this aspect of the invention, the composition of the invention comprises bifenthrin in a concentration from 20% to 30% w/v, preferably from 20% to 28% w/v, more preferably from 24% to 27% w/v, even more preferably from 25% w/v to 26% w/v.

In another embodiment of this aspect of the invention, the composition of the invention comprises cyclohexanone in a concentration from 30% to 35% w/v, preferably from 32% to 34% w/v.

In another embodiment of this aspect of the invention, the composition of the invention comprises FAME in a concentration from 1.5% to 2.5% w/v, preferably from 1.8% to 2.2% w/v, more preferably from 1.9% to 2.1% w/V.

In another embodiment of this aspect of the invention, the composition of the invention comprises calcium phenyl sulfonate (70% w/w) in a concentration from 9.5% to 10.5% w/v, preferably from 9.75% to 10.25% w/v.

In another embodiment of this aspect of the invention, the composition of the invention comprises the EO/PO block copolymer in a concentration from 9% to 11% w/v, preferably from 9.5% to 11% w/v, more preferably from 9.5% to 10.5% w/v.

In another embodiment of this aspect of the invention, the composition of the invention comprises castor oil ethoxylate in a concentration from 9% to 11% w/v, preferably from 9.5% to 10.5% w/v, more preferably from 9.75% to 10.25% w/v.

In another embodiment of this aspect of the invention, the composition of the invention comprises tristyrylphenol ethoxylate in a concentration from 4.5% to 5.5% w/v, preferably from 4.5% to 5.25% w/v, more preferably from 4.9% to 5.1% w/v.

In a preferred embodiment of this aspect of the invention, the composition further comprises epoxidized soybean oil. Preferably, the epoxidized soybean oil is present in the composition in a concentration from 0.9 to 1.1% w/v.

In a particularly preferred embodiment of this aspect of the invention, the composition comprises:
25.0% w/v bifenthrin,
33.0% w/v cyclohexanone,
2.0% w/v FAME,
1.0% w/v epoxidized soybean oil,
10.0% w/v calcium phenyl sulfonate (70% w/w),
10.0% w/v EO/PO block copolymer,
10.0% w/v castor oil ethoxylate,
5.0% w/v tristyrylphenol ethoxylate, and
water q.s. 100 ml.

In another embodiment of this aspect of the invention, the composition further comprises at least one additional insecticidal active ingredient.

In a particular embodiment of this aspect of the invention, the composition further comprises acetamiprid.

In yet another particular embodiment of this aspect of the invention, the composition further comprises acetamiprid and chlorpyrifos.

It is another aspect of the present invention to provide an agricultural composition comprising bifenthrin, thiamethoxam, cyclohexanone, calcium phenyl sulfonate, castor oil ethoxylate, a polyalkylene oxide block copolymer, tristyrylphenol ethoxylate and water.

In an embodiment of this aspect of the invention, the composition further comprises dimethyl sulfoxide (DMSO).

In another embodiment of this aspect of the invention, the composition further comprises epoxidized soybean oil.

In yet another embodiment of this aspect of the invention, the composition further comprises ethanol.

In yet another embodiment of this aspect of the invention, the composition further comprises iso-tridecyl alcohol polyglycol ether.

In a particularly preferred embodiment of this aspect of the invention, the composition comprises:
2.5% w/v bifenthrin,
5.0% w/v thiamethoxam,
27.0% w/v cyclohexanone,
16.0% w/v DMSO,
1.0% w/v epoxidized soybean oil,
14.0% w/v ethanol,
3.0% w/v calcium phenyl sulfonate,
10.0% w/v polyalkylene oxide block copolymer,
9.0% w/v castor oil ethoxylate,
3.0% w/v tristyrylphenol ethoxylate,
5.0% w/v iso-tridecyl alcohol polyglycol ether, and
water q.s 100 ml.

It is yet another aspect of the present invention to provide a method for controlling an insect plague in a crop, the method comprising applying an effective amount of the agricultural composition of the invention to the crop.

### BRIEF DESCRIPTION OF THE DRAWINGS

FIG. 1. Percentage of damaged fruits in each treatment in the prior assessment of tomato plants at Site 1 (Aslam variety).

FIG. 2. Percentage of damaged fruits in each treatment in the second assessment of tomato plants at Site 1 (Aslam variety).

FIG. 3. Percentage of damaged fruits in each treatment in the third assessment of tomato plants at Site 1 (Aslam variety).

FIG. 4. Percentage of damaged fruits in each treatment in the prior assessment of tomato plants at Site 2 (Parce variety).

FIG. 5. Percentage of damaged fruits in each treatment in the second assessment of tomato plants at Site 2 (Parce variety).

FIG. 6. Percentage of damaged fruits in each treatment in the third assessment of tomato plants at Site 2 (Parce variety).

FIG. 7. Dose-response curves for effectiveness against Nezara viridula assessment.

### DETAILED DESCRIPTION OF THE INVENTION

The present invention is directed to agricultural compositions comprising bifenthrin, in the form of microemulsions.

The term “microemulsion” is to be understood throughout this description as commonly interpreted by those of skill in the art. Briefly, a microemulsion is a thermodynamically stable system comprising small droplets of a liquid phase dispersed within another liquid, continuous phase. The droplets may typically have diameters in the range of 0.01 μm to 0.05 μm.

The microemulsions of the present invention are kept stable both during storage and when diluted for application, due to the specific solvents/surfactants system they comprise, which not only achieves a more efficient (i.e., lower) dosage of bifenthrin to the crop for which protection is sought, but also surprisingly enables an unordinary high concentration of said active ingredient to be stably present in the composition. This provides the unexpected additional advantage of a comparatively low amount of composition needed to be applied to the crop for achieving a proper insecticidal effect.

Therefore, it is an aspect of the present invention to provide an agricultural composition comprising bifenthrin, cyclohexanone, calcium phenyl sulfonate, castor oil ethoxylate, tristyrylphenol ethoxylate, fatty acid methyl esters (FAME), a polyalkylene oxide block copolymer, and water.

As mentioned, the agricultural composition of the invention comprises bifenthrin as active ingredient in a comparably high concentration while maintaining its stability as a microemulsion. In this regard, it should be noted that, for instance, prior art documents CN 101984808 A, CN 104872114 A and U.S. Pat. No. 6,251,415 B1 describe microemulsions comprising, at most, 10% w/w bifenthrin. The composition of the present invention, on the other hand, is able to load a much higher bifenthrin concentration. Correspondingly, in a preferred embodiment, the composition of the invention comprises bifenthrin in a concentration from 20% to 30% w/v, preferably from 20% to 28% w/v, more preferably from 24% to 27% w/v, even more preferably from 25% w/v to 26% w/v.

The cyclohexanone present in the composition of the invention acts as a solvent for bifenthrin. In a particular embodiment of this aspect of the invention, the composition of the invention comprises cyclohexanone in a concentration from 30% to 35% w/v, preferably from 32% to 34% w/v.

The term “fatty acid methyl esters” or “FAME” is to be understood as referring to a mixture of methyl esters derived from fatty acids obtained from plants. For example, the FAME may be FAME from soybean plants. In the composition of the invention, FAME have a key role as a co-solvent for the active ingredient. In a particular embodiment of the invention, the composition of the invention comprises FAME in a concentration from 1.5% to 2.5% w/v, preferably from 1.8% to 2.2% w/v, more preferably from 1.9% to 2.1% w/v.

The calcium phenyl sulfonate present in the composition acts as a surfactant for stabilizing the emulsion. It is typically added to the composition dissolved in an appropriate solvent, such as isobutanol. Preferably, the calcium phenyl sulfonate is added as a 70% w/w solution in isobutanol. Unless otherwise specified, any reference to a concentration of calcium phenyl sulfonate in the compositions of the invention is to be understood as the concentration of 70% w/w calcium phenyl sulfonate solution in isobutanol added thereto. In an embodiment of the invention, the composition of the invention comprises calcium phenyl sulfonate (70% w/w) in a concentration from 9.5% to 10.5% w/v, preferably from 9.75% to 10.25% w/v.

The term “polyalkylene oxide block copolymer” is widely known for those of skill in the art, and refers to a copolymer having at least two “blocks” of covalently bound polyalkylene oxide homopolymers derived from alkylene oxides with different carbon chain lengths. For instance, in a preferred embodiment, the polyalkylene oxide block copolymer is an ethylene oxide/propylene oxide block copolymer (or EO/PO block copolymer), which refers to a copolymer having at least two “blocks” of covalently bound polyethylene oxide and polypropylene oxide homopolymers. Several such copolymers are known in the art, such as certain products of the Emulsogen® series commercialized by Clariant or the Atlas® G-5000 series commercialized by Croda.

In the composition of the present invention, the polyalkylene oxide block copolymer acts as an emulsifier. In an embodiment of the invention, the composition of the invention comprises an EO/PO block copolymer in a concentration from 9% to 11% w/v, preferably from 9.5% to 11% w/v, more preferably from 9.5% to 10.5% w/v.

The term “castor oil ethoxylate” is well within the common knowledge expected for a person of skill in the art. It refers to the condensation product of the reaction between castor oil and ethylene oxide, upon which a compound with varying amounts of polyethylene oxide moles might be generated. For example, the castor oil ethoxylate used in the present invention may be 36 moles castor oil ethoxylate, meaning that an average 36 moles of polyethylene oxide were added per mole of castor oil. It is a known emulsifier for agricultural compositions. In an embodiment of the invention, the composition of the invention comprises castor oil ethoxylate in a concentration from 9% to 11% w/v, preferably from 9.5% to 10.5% w/v, more preferably from 9.75% to 10.25% w/v.

The term “tristyrylphenol ethoxylate” is well within the common knowledge expected for a person of skill in the art. It refers to the condensation product of the reaction between tristyrylphenol and ethylene oxide, upon which a compound with varying amounts of polyethylene oxide moles might be generated. For example, the tristyrylphenol ethoxylate used in the present invention may be 20 moles tristyrylphenol ethoxylate, meaning that an average 20 moles of polyethylene oxide were added per mole of tristyrylphenol. In an embodiment of the invention, the composition of the invention comprises tristyrylphenol ethoxylate in a concentration from 4.5% to 5.5% w/V, preferably from 4.5% to 5.25% w/v, more preferably from 4.9% to 5.1% w/v.

The composition of the invention also comprises water, which provides the aqueous phase of the microemulsion. Unless specified otherwise, the concentration of water comprised in the composition is that necessary to reach a volume such that the concentrations of the other ingredients of the composition are as specified (expressed as “q.s. 100 ml” throughout this description).

The composition of the invention may further comprise additional adjuvants apart from the base solvent/surfactant system thereof, which may aid to obtain optimal results in particular embodiments of the invention. For instance, in a preferred embodiment of the invention, the composition further comprises epoxidized soybean oil. More preferably, the epoxidized soybean oil is present in the composition in a concentration from 0.9 to 1.1% w/v.

In a particularly preferred embodiment of this aspect of the invention, the composition comprises:
25.0% w/v bifenthrin,
33.0% w/v cyclohexanone,
2.0% w/v FAME,
1.0% w/v epoxidized soybean oil,
10.0% w/v calcium phenyl sulfonate (70% w/w),
10.0% w/v EO/PO block copolymer,
10.0% w/v castor oil ethoxylate,
5.0% w/v tristyrylphenol ethoxylate, and
water q.s. 100 ml.

The composition of the invention not only surprisingly allows for a comparatively high concentration of bifenthrin to be comprised therein, but also has the additional advantage of being versatile, being able to accommodate other insecticidal active ingredients additionally to bifenthrin. Therefore, according to another embodiment of the present invention, the composition further comprises at least one additional insecticidal active ingredient.

The at least one additional insecticidal active ingredient may be selected from any such insecticidal active ingredients which are compatible with bifenthrin, as any person of skill in the art will appreciate. For instance, the at least one additional insecticidal active ingredient may be a pyrethroid other than bifenthrin. Alternatively, it may be an insecticide belonging to the family of the neonicotinoids, or to the family of the organophosphates.

In a particular embodiment of the invention, the composition further comprises acetamiprid. In another particular embodiment of the invention, the composition further comprises acetamiprid and chlorpyriphos.

When the composition comprises additional active ingredients, it allows for a lower concentration of bifenthrin to be used, since the total insecticidal effect is the combination of the contributions of each active ingredient. Therefore, in an embodiment of the invention, the composition further comprises at least one additional insecticidal active ingredient, wherein bifenthrin is present in a concentration from 3.5% to 10.5% w/v. Preferably, the at least one additional insecticidal active ingredient is selected from acetamiprid, chlorpyriphos, and a mixture thereof.

In a particular embodiment of the invention, the composition comprises 10.3% w/V bifenthrin and 10.3% w/v acetamiprid. In another particular embodiment of the invention, the composition comprises 3.7% w/v of bifenthrin, 4.2% w/v of acetamiprid and 26.0% w/v of chlorpyrifos.

When other active ingredients apart from bifenthrin are present in the composition, it may be beneficial to include additional components to improve, for instance, the solubility thereof. Particularly, if such active ingredients exhibit acidic or alkaline properties, including pH adjusting components might be convenient.

Therefore, in an embodiment of the invention, when the composition comprises at least one additional insecticidal active ingredient selected from acetamiprid, chlorpyriphos, and a mixture thereof, it further comprises glacial acetic acid. Preferably, the glacial acetic acid is present in a concentration from 0.07% to 0.075% w/v.

In a particularly preferred embodiment of the invention, the composition comprises:
10.0% w/v bifenthrin,
10.0% w/v acetamiprid,
45.0% w/v cyclohexanone,
5.0% w/v FAME,
0.5% w/v epoxidized soybean oil,
8.0% w/v calcium phenyl sulfonate (70% w/w),
8.0% w/v EO/PO block copolymer,
9.0% w/v castor oil ethoxylate,
5.0% w/v tristyrylphenol ethoxylate,
0.075% w/v glacial acetic acid, and
water q.s. 100 ml.

In another particularly preferred embodiment of the invention, the composition comprises:
3.5% w/v bifenthrin,
4.0% w/v acetamiprid,
25.0% w/v chlorpyriphos,
26.0% w/v cyclohexanone,
5.0% w/v FAME,
5.0% w/v calcium phenyl sulfonate (70% w/w),
5.0% w/v EO/PO block copolymer,
12.0% w/v castor oil ethoxylate,
9.0% w/v tristyrylphenol ethoxylate,
0.07% w/v glacial acetic acid, and
water q.s. 100 ml.

It is another aspect of the present invention to provide an agricultural composition comprising bifenthrin, thiamethoxam, cyclohexanone, calcium phenyl sulfonate, castor oil ethoxylate, a polyalkylene oxide block copolymer, tristyrylphenol ethoxylate and water.

Thiamethoxam is yet another known insecticidal active ingredient belonging to the family of the neonicotinoids. The composition of this aspect of the invention is able to carry an effective amount of a combination of bifenthrin and thiamethoxam, further demonstrating the versatility of the present invention.

In a preferred embodiment of this aspect of the invention, the composition comprises bifenthrin in a concentration from 2% to 3% w/v, preferably from 2.25% to 2.75% w/v.

In another preferred embodiment of this aspect of the invention, the composition comprises thiamethoxam in a concentration from 4.5% to 5.5% w/v, preferably from 4.75% to 5.25% w/v.

The cyclohexanone present in the composition of this aspect of the invention acts as a solvent for the active ingredients. In a particular embodiment of this aspect of the invention, the composition of the invention comprises cyclohexanone in a concentration from 25% to 29% w/v, preferably from 26% to 28% w/v.

The calcium phenyl sulfonate present in the composition of this aspect of the invention acts as a surfactant for stabilizing the emulsion. In an embodiment of the invention, the composition of the invention comprises calcium phenyl sulfonate (70% w/w in isobutanol) in a concentration from 2% to 4% w/v, preferably from 2.5% to 3.5% w/v.

In an embodiment of the invention, the composition of this aspect of the invention comprises castor oil ethoxylate in a concentration from 8% to 10% w/v, preferably from 8.5% to 9.5% w/v.

In an embodiment of the invention, the composition of this aspect of the invention comprises tristyrylphenol ethoxylate in a concentration from 2.5% to 3.5% w/v, preferably from 2.75% to 3.25% w/v.

In an embodiment of the invention, the composition of this aspect of the invention comprises a polyalkylene oxide block copolymer in a concentration from 9% to 11% w/v.

The composition of this aspect of the invention may further comprise additional adjuvants apart from the base solvent/surfactant system thereof described above, which may aid to obtain optimal results in particular embodiments of the invention.

For instance, in a preferred embodiment of this aspect of the invention, the composition further comprises dimethyl sulfoxide (DMSO) as a co-solvent for the active ingredients. Preferably, the DMSO is present in the composition in a concentration from 14% to 18% w/v.

In another preferred embodiment of this aspect of the invention, the composition further comprises epoxidized soybean oil. Preferably, the epoxidized soybean oil is present in the composition in a concentration from 0.5% to 1.5% w/v.

In a preferred embodiment of this aspect of the invention, the composition comprises further ethanol, preferably in a concentration from 13% to 15% w/v.

The composition of this aspect of the invention may further comprise an iso-tridecyl alcohol polyglycol ether. The term “iso-tridecyl alcohol polyglycol ether” is to be understood referring to the condensation product between iso-tridecyl alcohol and ethylene oxide, upon which a compound with varying amounts of polyethylene oxide moles might be generated. For example, the iso-tridecyl alcohol polyglycol ether used in the present invention may be 6 moles iso-tridecyl alcohol polyglycol ether, meaning that an average 6 moles of polyethylene oxide were added per mole of iso-tridecyl alcohol. In an embodiment of this aspect of the invention, the composition of the invention comprises iso-tridecyl alcohol polyglycol ether in a concentration from 4.5% to 5.5% w/v.

In a particularly preferred embodiment of this aspect of the invention, the composition comprises:
2.5% w/v bifenthrin,
5.0% w/v thiamethoxam,
27.0% w/v cyclohexanone,
16.0% w/v DMSO,
1.0% w/v epoxidized soybean oil,
14.0% w/v ethanol,
3.0% w/v calcium phenyl sulfonate,
10.0% w/v polyalkylene oxide block copolymer,
9.0% w/v castor oil ethoxylate,
3.0% w/v tristyrylphenol ethoxylate,
5.0% w/v iso-tridecyl alcohol polyglycol ether, and
water q.s. 100 ml.

The compositions of the present invention are useful in controlling harmful insects in crops of agronomical interest. Therefore, it is yet another aspect of the invention to provide a method for controlling an insect plague in a crop, the method comprising applying an effective amount of a composition of the invention to the crop.

The compositions of the invention may be applied to any crop of agronomical interest which is in risk of suffering from biotic stress due to harmful insects. In a particular embodiment of this aspect of the invention, the crop is selected from the group consisting of peach, apple, potato, pear, soybean, banana, cotton, canola, corn, citrus, vines, sugar cane, tomato, apricot, ornamentals, tobacco, eggplant. Preferably, the crop is selected from the group consisting of soybean and tomato.

The compositions of the invention allow for the control of a large number of different insect plagues. In a particular embodiment of this aspect of the invention, the insect plague is selected from the group consisting of Myzus persicae, Tetranychus urticae, Panonychus ulmi, Oiketicus platensis, Cercopoidea spp., Cydia pomonella, Cacopsylla pyricola, Bemisia tabaci, Piezodorus guildinii, Nezara viridula, Anticarsia gemmatalis, Caliothrips phaseoli, Tetranychus telarius, Agrypnus spp., Helicoverpa punctigera, Helicoverpa armigera, Aculops lycopersici, Trialeurodes vaporariorum, Pseudococcus longispinus, Acalolepta vastator, Eutinophaea bicristata, Carpophilus spp., Listroderes difficilis, Hednota spp., Ciampa arietaria, Chrysodeixis includens, Heliothis virescens, Spododoptera spp., and Neoleucinodes elegantalis. Preferably, the insect plague is selected from the group consisting of Neoleucinodes elegantalis, Anticarsia gemmatalis, Chrysodeixis includens, Helicoverpa armigera, Heliothis virescens, and Spododoptera spp.

The effective amount to be applied may depend on several factors, such as the specific composition encompassed by the invention to be used, the crop being treated, the target insect plague, among others. It is within the expected common knowledge for a person of skill in the art to determine an appropriate effective amount of the composition for application in each case.

For instance, when the composition comprises 25% w/v bifenthrin, the effective amount of the composition to be applied may be in the range from 20 to 200 cm³/ha.

The compositions of the present invention may be obtained by techniques widely known to a person of average skill in the art, and may be optimized by means of routine experimentation. The following examples provide indications of how to prepare representative embodiments of the invention. As such, they should be taken as merely exemplary embodiments, not intended to limit the scope of the invention.

### EXAMPLES

In the following Examples, the following commercial products were used for the preparation of the compositions.
EO/PO block copolymer: Emulsogen® EP 4901 (Clariant)
Castor oil ethoxylate: Emulsogen® EL360 (Clariant)
Tristyrylphenol ethoxylate: Emulsogen® TS200 (Clariant)
Polyalkylene glycol ether polymer (polyalkylene oxide block copolymer): Atlas™ MG-5002L (Croda Crop Care)
Iso-tridecyl alcohol polyglycol ether: Genapol® X 060 (Clariant)

### Example 1—Preparation of Compositions Comprising Bifenthrin

The following compositions comprising bifenthrin as the sole active compound were prepared.

TABLE 1
Compositions comprising bifenthrin

| | Concentration (% w/v) | | |
|---|---|---|---|
| Ingredient | 1 | 2 | 3 |
| Bifenthrin | 20.0 | 25.0 | 27.0 |
| Cyclohexanone | 30.0 | 33.0 | 35.0 |
| FAME | 1.8 | 2.0 | 2.2 |
| Epoxidized soybean oil | 0.9 | 1.0 | 1.1 |
| Calcium phenyl sulfate | 9.5 | 10.0 | 10.5 |
| (70% w/w in isobutanol) | | | |
| Emulsogen ® EP 4901 | 9.5 | 10.0 | 11 |
| Emulsogen ® EL360 | 9.3 | 10.0 | 10.4 |
| Emulsogen ® TS200 | 4.5 | 5.0 | 5.1 |
| Water | q.s. 100 ml | q.s. 100 ml | q.s. 100 ml |

The compositions of Table 1 were prepared as follows (the amounts apply for composition 2):

2 g of FAME and 1 g of epoxidized soybean oil were added to 33 g of cyclohexanone under stirring. While still stirring, 25 g of bifenthrin were added. In a separate beaker, 5 g of Emulsogen® TS200 were poured and, while stirring, 10 g of Emulsogen® EL360, 10 g of Emulsogen® EP 4901 and 10 g of calcium phenyl sulfate (70% w/w) were added.

The mixture of surfactants described above was added to the beaker containing the mixture of cyclohexanone and bifenthrin, stirring until a complete homogenization was obtained. Then water was added until a total volume of 100 mL was reached, and the system was stirred until a homogeneous and crystalline formulation was obtained.

### Example 2—Preparation of Compositions Comprising Bifenthrin in Combination with Acetamiprid and Chlorpyriphos

The following compositions were prepared, using a preparation protocol similar to the one described in Example 1.

TABLE 2
Compositions comprising bifenthrin, acetamiprid and chlorpyriphos

Concentration (% w/v)

| Ingredient | 4 | 5 |
|---|---|---|
| Bifenthrin | 10.0 | 3.5 |
| Acetamiprid | 10.0 | 4.0 |
| Chlorpyriphos | — | 25.0 |
| Cyclohexanone | 45.0 | 26.0 |
| FAME | 5.0 | 5.0 |
| Calcium phenyl sulfonate | 8.0 | 5.0 |
| (70% w/w in isobutanol) | | |
| Emulsogen ® EP 4901 | 8.0 | 5.0 |
| Emulsogen ® EL360 | 9.0 | 12.0 |
| Emulsogen ® TS200 | 5.0 | 9.0 |
| Glacial acetic acid | 0.075 | 0.07 |
| Epoxidized soybean oil | 0.5 | — |
| Water | q.s. 100 ml | q.s. 100 ml |

### Example 3—Preparation of Compositions Comprising Bifenthrin in Combination with Thiamethoxam

The following compositions were prepared, using a preparation protocol similar to the one described in Example 1.

TABLE 3
Composition comprising bifenthrin and thiamethoxam

| | Concentration (% w/v) |
|---|---|
| Ingredient | Composition 6 |
| Thiamethoxam | 5.0 |
| Bifenthrin | 2.5 |
| Cyclohexanone | 27.0 |
| DMSO | 16.0 |
| Epoxidized soybean oil | 1.0 |
| Bioethanol | 14.0 |
| Calcium phenyl sulfonate | 3.0 |
| (70% w/w in isobutanol) | |
| Atlas ™ G-5002L | 10.0 |
| Emulsogen ® EL 360 | 9.0 |
| Emulsogen ® TS 200 | 3.0 |
| Genapol ® X060 | 5.0 |
| Water | q.s. 100 ml |

### Example 4—Assessment of Comparative Compositions

Comparative compositions were prepared according to the teachings of WO2021224670A1, considering the examples most closely related to the compositions of the present invention, replacing the active ingredient used therein (promethrin) with bifenthrin, with a concentration of the active ingredient of 25% w/v, for a direct comparation with Composition 2 described in Example 1, and adjusting the concentrations of some ingredients to compensate for the difference in the shift volume of promethrin and bifenthrin.

TABLE 4
Formulation of Comparative composition 1
Comparative composition 1, based on formulation 7 of WO2021224670A1

| | Concentration |
|---|---|
| Ingredient | (% w/v) |
| Bifenthrin | 25.0 |
| Genagen ® 4166 | 48.0 |
| (dimethylamide of C8/C10 | |
| fatty acid, Clariant) | |
| FAME | 2.0 |
| Calcium phenyl sulfonate | 2.5 |
| (70% w/w in isobutanol) | |
| Water | 30.0 |

TABLE 5
Formulation of Comparative composition 2
Comparative composition 2, based on formulation 4 of WO2021224670A1

| | Concentration |
|---|---|
| Ingredient | (% w/v) |
| Bifenthrin | 25.0 |
| Xylene | 47.0 |
| FAME | 2.0 |
| Calcium phenyl | 2.5 |
| sulfonate (70% w/w in | |
| isobutanol) | |
| Atlas ™ G-5002L | 5.0 |
| Emulsogen ® TS200 | 16.0 |
| Propylene glycol | 11.0 |

The formulations disclosed in WO20212246/0A1 were assayed to ascertain whether stable bifenthrin microemulsions could be obtained from the teachings thereof. It was observed that only Comparative compositions 1 and 2 described above allowed a dissolution of bifenthrin at 25% w/v. However, the microemulsion obtained with Comparative composition 1 was not stable, observing a separation of phases by 30 minutes after the preparation, while Comparative composition 2 did not generate a microemulsion rather than an emulsifiable concentrate. Additionally, a dilution to 5% of Comparative composition 2 was assayed, to simulate the conditions upon which it would be applied to crops, and it was found that the obtained diluted emulsion was not stable.

In contrast, the compositions according to the invention afford stable microemulsions, which may in turn be stably diluted for application.

### Example 5—Effectiveness of a Composition According to the Invention in the Control of Defoliating Caterpillars in Soybean Crops

The experimental design utilized in the experiment was a completely random block design, with four repetitions of the six treatments. The experimental unit was constituted by 6 ten-meter-long rows of the Garra variety of soybean with a density of 62,500 plants per hectare (separation of 0.45 m between rows).

Table 6 below shows the studied treatments for the experiment.

Table 6: Experimental design of the effectiveness assay

| | Active | Dose | |
|---|---|---|---|
| Treatments | ingredient | (cm³/ha) | Target insects |
| 1 Composition 2 | Bifenthrin 25% | 25 | Anticarsia gemmatalis |
| 2 Composition 2 | | 30 | Chrysodeixis includens |
| 3 Composition 2 | | 35 | Heliothis verscens |
| Chemical control (Cofenrin ®, | Bifenthrin 40% | 35 | Helicoperva armigera |
| 4 Bifenthrin 40% EC) | | | Spodoptera spp. |
| 5 Untreated control | — | — | |

Methodology

| | | |
|---|---|---|
| Design: CRBD | Parcel size: 2.7 m × 5 m = 13.5 m² | No. of repetitions: 4 |

Application criteria: for defoliating caterpillars, search homogeneous parcels, with a majority of
small caterpillars, if possible.
Application timing: vertical beating cloth is used, finding 10 caterpillars per beating cloth.
Application technology: a sack sprayer is used at constant CO₂ pressure with a water volume
of 150 L.

For the assay, parcels that were sowed with soybean and received a basic fertilization of 120 k/ha of Apr. 30, 2010 fertilizer were selected. At the moment of sowing, said parcels came from a wheat crop at winter. Sampling was carried out on the same day to ensure the presence of target pests. The insecticides were applied with a gas sprayer at constant pressure at the R3/R4 phenological stage of the crop. The volume of broth used was 150 l/ha.

The assay was carried out in Capitán Miranda, Itapúa, Paraguay. The sowing took place on Feb. 9, 2022, and the insecticide was applied on Apr. 26, 2022. The number of caterpillars found alive was evaluated on three occasions: 3, 7 and 14 days after application of the insecticide.

For the assessment of the presence of the target insects the cloth method was used, counting the number of small and big caterpillars fallen in the cloth in each treatment, in each evaluation time. The caterpillars were discriminated by species and development stage of the target insect, considering a small caterpillar beginning at L2.

The control efficiency percentage of each treatment was calculated by means of the Henderson & Tilton formula, % Mortality=100×[1−(Ia×Id)/(Td×Ta)], wherein: Id=number of insects in the treatment after application; Ia=number of insects in the treatment prior to the application; Td=number of insects in the control after application; and Ta=number of insects in the control prior to the application. The percentages are aligned in a selectivity scale: 0-20%=selective(S); 21-40%=low toxicity (LT); 41-60=moderate toxicity (MT); 61-80%=toxic (T); and 81-100%=highly toxic (HT).

### Results and Discussion

Table 7 shows the average number of small caterpillars found alive in the assay, where in the first evaluation carried out at 3 DAA (days after application) the average and maximum doses of the composition of the invention (Composition 2 as described in Example 1) and the chemical control Bifenthrin 40% exhibited statistical differences in comparison with the untreated control. In the second and third assessments (7 and 14 DAA) every dose of the composition of the invention as well as the chemical control exhibited statistical differences compared to the untreated control. All the different doses of the composition of the invention are statistically equal to each other and to the chemical control.

TABLE 7
Small caterpillars detected in 2 m row for each treatment.

| | | | Average small caterpillars | | | | | | | | |
|---|---|---|---|---|---|---|---|---|---|---|---|
| | | Dose | 1^{st} assessment | | | 2^{nd} assessment | | | 3^{rd} assessment | | |
| Treatments | | cm³/ha | X¹ | | % E3 | X | | % E | X | | % E |
| 1 | Comp. 2 | 25 | 2.17 | B² | 33 | 1.21 | A | 85 | 1.21 | A | 85 |
| 2 | Comp. 2 | 30 | 1.37 | A | 86 | 1.10 | A | 100 | 1.10 | A | 95 |
| 3 | Comp. 2 | 35 | 1.49 | A | 70 | 1.31 | A | 74 | 1.18 | A | 83 |
| 4 | Chem. control | 35 | 1.62 | A | 71 | 1.31 | A | 71 | 1.18 | A | 81 |
| 5 | Untr. control | — | 2.56 | B | — | 1.93 | B | — | 1.93 | B | — |

| | | | |
|---|---|---|---|
| VC(%) | 14.76 | 16.95 | 20.42 |
| p-value | 0.0002* | 0.0026** | 0.0050** |

¹Average of four repetitions, data transformed (x + 1)\hat{ }(0.5).
²Same letters do not present significative differences. LSD test at 5%.
³Efficiency percentage found by the Henderson & Tilton Formula

Regarding the toxicity efficiency found in the assay, it was observed that, in the first evaluation, the lowest dose of the composition of the invention exhibited low toxicity to control small caterpillars. The medium dose showed a highly toxic efficiency, and the maximum dose showed an average efficiency of toxicity for the control of small caterpillars. In the second and third evaluations carried out at 07 and 14 DAA, all doses (minimum, medium and maximum) of the composition of the invention were highly toxic for the control of small caterpillars.

Table 8 shows the average number of large caterpillars found alive in the assay. In the first evaluation, the minimum dose (25 cm³/ha) and the maximum dose (35 cm³/ha) of the composition of the invention exhibited statistical differences compared to the untreated control. In the second evaluation, all doses of the composition of the invention showed statistical differences with the untreated control, as did the chemical control. The medium and maximum doses exhibited a lower average number of large caterpillars found alive. In the last evaluation, the maximum dose of the composition of the invention showed statistical differences when compared to the untreated control. The minimum and medium doses of the composition of the invention exhibited statistical similarity with the untreated control.

TABLE 8
Small caterpillars detected in 2 m row for each treatment.

| | | | Average large caterpillars | | | | | | | | |
|---|---|---|---|---|---|---|---|---|---|---|---|
| | | Dose | 1^{st} assessment | | | 2^{nd} assessment | | | 3^{rd} assessment | | |
| Treatments | | cm³/ha | X¹ | | % E³ | X | | % E | X | | % E |
| 1 | Comp. 2 | 25 | 1.37 | A² | 76 | 1.64 | B | 46 | 1.41 | AB | 48 |
| 2 | Comp. 2 | 30 | 1.82 | AB | 40 | 1.10 | A | 99 | 1.41 | AB | 62 |
| 3 | Comp. 2 | 35 | 1.64 | A | 40 | 1.18 | A | 77 | 1.21 | A | 70 |
| 4 | Chem. control | 35 | 1.79 | A | 43 | 1.29 | AB | 75 | 1.29 | A | 66 |
| 5 | Untr. control | — | 2.49 | B | — | 2.23 | C | — | 1.96 | B | — |

| | | | |
|---|---|---|---|
| VC(%) | 24.94 | 16.99 | 25.37 |
| p-value | 0.0464* | 0.0002** | 0.0919 ns |

¹Average of four repetitions, data transformed (x + 1)\hat{ }(0.5).
²Same letters do not present significative differences. LSD test at 5%.
³Efficiency percentage found by the Henderson & Tilton Formula

In terms of efficiency, in the first evaluation, the minimum dose of the composition of the invention exhibited good toxicity efficiency for the control of large caterpillars. In the second evaluation, the medium dose exhibited a highly toxic efficiency for controlling large caterpillars. The maximum dose of the composition of the invention and the chemical control exhibited good toxicity efficiency against large caterpillars. In the last evaluation, the maximum dose of the composition of the invention showed good toxicity efficiency against large caterpillars.

### Conclusions

For the control of defoliating caterpillars in soybean crops, Composition 2 as described in Example 1 exhibited moderate to very good toxicity efficiencies both for large- and small-sized caterpillars.

### Example 6—Effectiveness of a Composition According to the Invention in the Control of Neoleucinodes elegantalis in Tomato Crops

The assay was carried out in tomato crops at two different sites (Sites 1 and 2), in Cajamarca, Tolima, Colombia. The crop at Site 1 is of the Aslam variety, while the crop at Site 2 is of the Parce variety.

A RCB (Random Complete Blocks) design was used, with 4 repetitions or blocks, 4 treatments with Composition 2 described in Example 1, one with a commercial control (Brigada® 100 EC, commercialized by FMC) and one with an absolute control (i.e., no insecticide), for a grand total of six treatments.

4 m long×4 m wide parcels were used (16 m²)×6 treatments×4 repetitions (total: 384 m²). Each parcel encompassed an approximate width of 4 furrows. Each treatment was applied once by land foliar application guaranteeing maximum coverage of the aerial part of the plant.

The following treatments were applied:

TABLE 9
Treatments applied to tomato crops

| Treatment | Product | Dose (cm³/ha) |
|---|---|---|
| T₀ | Absolute control | — |
| T₁ | Composition 2 | 50 |
| T₂ | Composition 2 | 100 |
| T₃ | Composition 2 | 150 |
| T₄ | Composition 2 | 200 |
| T₅ | Commercial control | 400 |

The assessments were made in the two central furrows of each parcel, where 10 plants were taken randomly. For each plant, the number of healthy and damaged fruits was counted. The incidence percentage per plant was thus calculated according to the following formula:

Incidence percentage per plant=number of affected fruits/total number of fruits×100

Three assessments were carried out: one before the application (Prior assessment) and two later assessments, in each harvest pass, with an interval of approximately one week.

The obtained results were subjected to a statistical analysis of variance, covariance, determination of the variation coefficient, and to the multiple averages comparison tests by the Tukey method at 5% probability. The data were processed by means of the statistical software INFOSTAT.

The efficacy of each treatment was determined based on the data obtained from the statistical analysis, thus establishing the best dose. For the assessment of the assay, the Abbott method was used, described below:

$$\% efficacy = [ 1 - ( \frac{Td}{Cd} ) ] * 100$$

where Td is the incidence in the parcel after treatment, and Cd is the incidence in the control parcel after treatment.

The possible phytotoxicity was also evaluated, both in the treatments with their respective doses, as well as in a surrounding area of 5 m², by performing an application of with twice the highest dose (400 cm³/ha) of Composition 2. The phytotoxicity was determined using the EWRS Score Scale in the same date of assessment of the assay.

TABLE 10
EWRS Score Scale

| Score | Phytotoxicity |
|---|---|
| 1 | Absolute absence of phytotoxicity |
| 2 | Very slight symptoms |
| 3 | Slight symptoms, but clearly noticeable |
| 4 | Clear symptoms (e.g., chlorosis), but not affecting harvest |
| 5 | Thinning of flora, strong chlorosis and/or atrophy. |
| 6 to 9 | Increasing damage up to death of the crop. |

### Results and Discussion

Site 1 (Aslam variety)

### Damaged Fruits Percentages

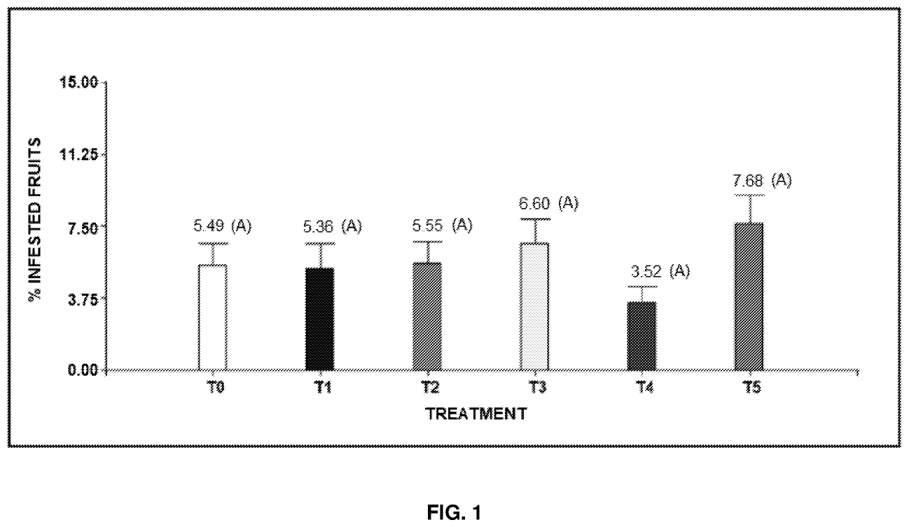

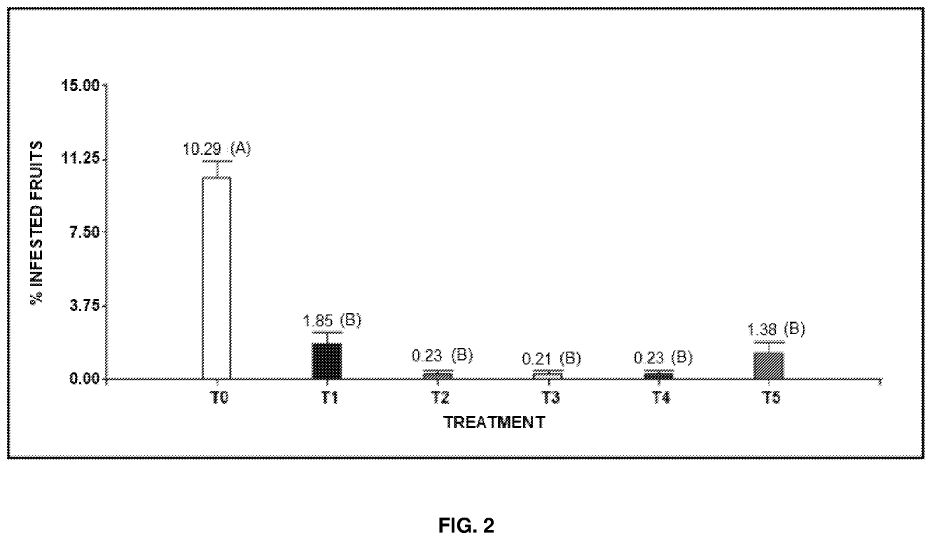

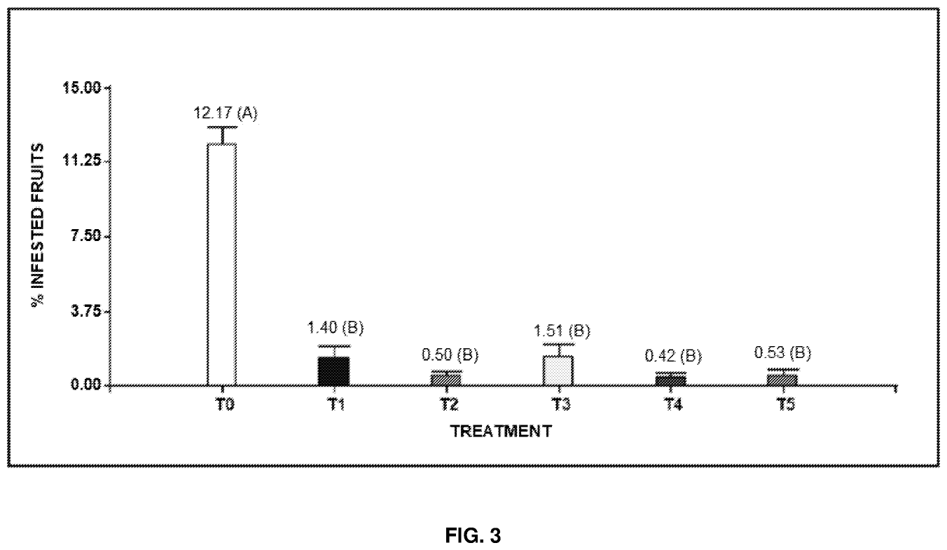

In the prior assessment, no significant differences were observed for treatments T₁, T₂, T₃, T₄ and T₅ relative to T₀ in the percentage of damaged fruits (FIG. 1). In the second and third assessments, significant differences were observed for all treatments T₁ to T₅ relative to the absolute control (FIG. 2 and FIG. 3, respectively).

### Efficacy Percentages

Table 11 shows the average results of efficacy obtained for each treatment. It can be observed that every treatment T₁ to T₅ exhibits an efficacy percentage higher that 80% relative to the absolute control.

TABLE 11
Efficacy percentages for each treatment
in tomato plants, Aslam variety

| Treatment | Product | % efficacy |
|---|---|---|
| T₁ | Composition 2 | 88.5 |
| T₂ | Composition 2 | 95.9 |
| T₃ | Composition 2 | 87.5 |
| T₄ | Composition 2 | 96.5 |
| T₅ | Commercial control | 95.6 |

### Phytotoxicity Test

No symptoms of phytotoxicity were observed in the area selected for the treatments, but symptoms were observed for twice the maximum dose applied for the phytotoxicity test. A score of 3 in the EWRS scale was recorded.

### Conclusions

According to the obtained results, the following conclusions were arrived to:
Composition 2 of the present invention is effective in the control of Neoleucinodes elegantalis in tomato crops.
The treatment with the highest effect was T₄ (Composition 2 at a dose of 200 cm³/ha), with an efficacy percentage of 96.5%.
Every dose of Composition 2 exhibited an excellent efficacy percentage, greater than 80%, in the control of Neoleucinodes elegantalis in tomato crops.
The possible phytotoxicity of Composition 2 was evaluated, obtaining a score of 3 (Slight symptoms, but clearly noticeable) based on the EWRS scale.
Composition 2 did not exhibit any effect on beneficial organisms in surrounding areas.
Site 2 (Parce variety)

### Damaged Fruits Percentages

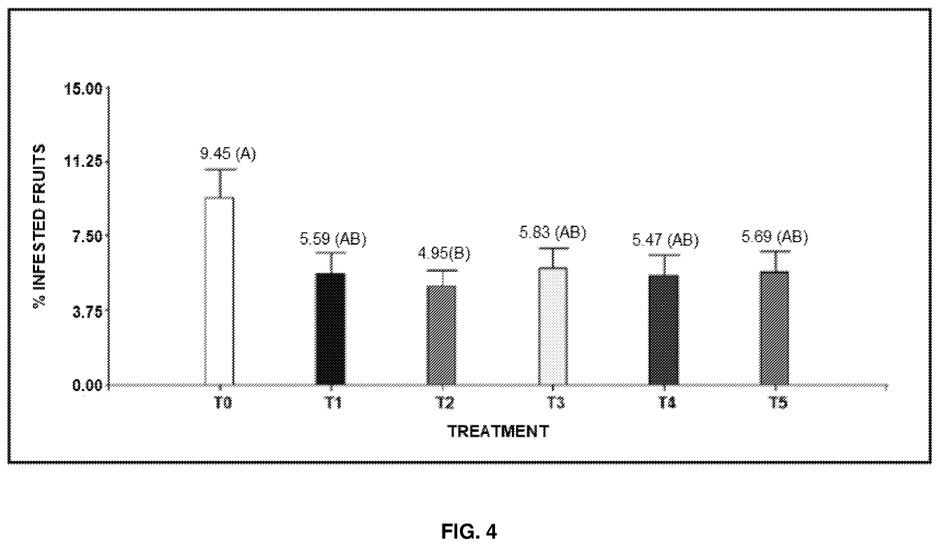

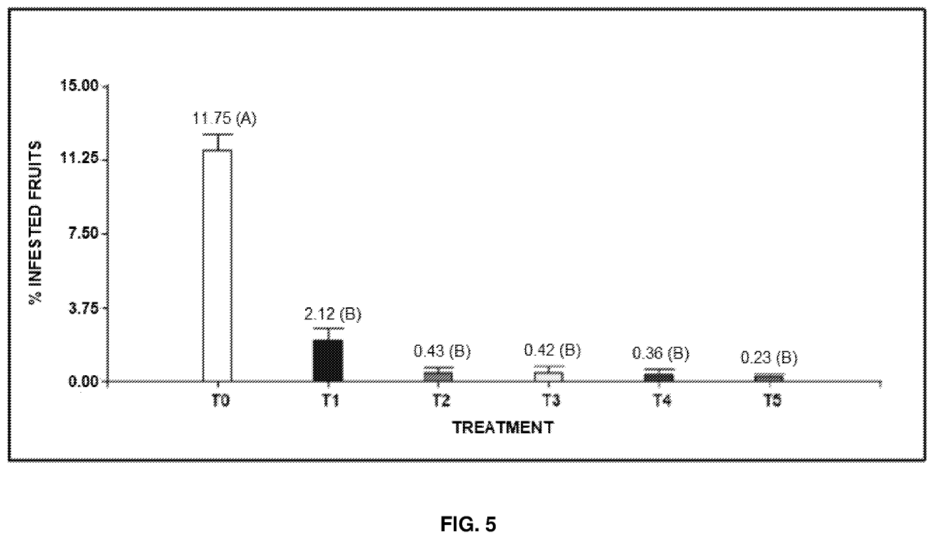

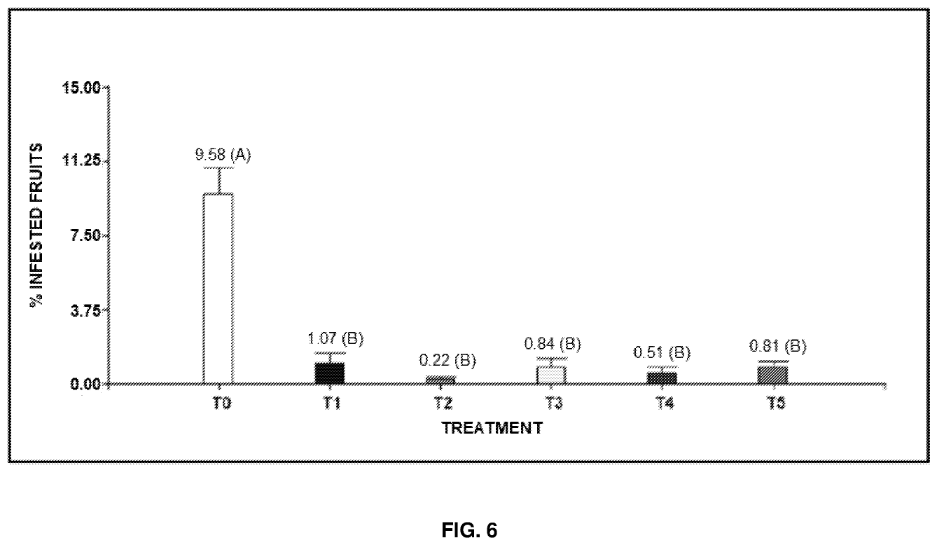

In the prior assessment, no significant differences were observed for treatments T₁, T₂, T₃, T₄ and T₅ relative to T₀ in the percentage of damaged fruits (FIG. 4). In the second and third assessments, significant differences were observed for all treatments T₁ to T₅ relative to the absolute control (FIG. 5 and FIG. 6, respectively).

### Efficacy Percentages

Table 12 shows the average results of efficacy obtained for each treatment. It can be observed that every treatment T₁ to T₅ exhibits an efficacy percentage higher that 80% relative to the absolute control.

TABLE 12
Efficacy percentages for each treatment
in tomato plants, Parce variety

| Treatment | Product | % efficacy |
|---|---|---|
| T₁ | Composition 2 | 88.8 |
| T₂ | Composition 2 | 97.7 |
| T₃ | Composition 2 | 91.2 |
| T₄ | Composition 2 | 94.7 |
| T₅ | Commercial control | 91.5 |

### Phytotoxicity Test

No symptoms of phytotoxicity were observed in the area selected for the treatments, but symptoms were observed for twice the maximum dose applied for the phytotoxicity test. A score of 3 in the EWRS scale was recorded.

### Conclusions

According to the obtained results, the following conclusions were arrived to:
Composition 2 of the present invention is effective in the control of Neoleucinodes elegantalis in tomato crops.
The treatment with the highest effect was T₂ (Composition 2 at a dose of 100 cm³/ha), with an efficacy percentage of 97.7%.
Every dose of Composition 2 exhibited an excellent efficacy percentage, greater than 80%, in the control of Neoleucinodes elegantalis in tomato crops.
The possible phytotoxicity of Composition 2 was evaluated, obtaining a score of 3 (Slight symptoms, but clearly noticeable) based on the EWRS scale.
Composition 2 did not exhibit any effect on beneficial organisms in surrounding areas.

### Example 7—In Vitro Effectiveness of a Bifenthrin Composition According to the Invention in the Control of Nezara viridula

Composition 2 as described in Example 1 was compared to a commercial product (Seizer® commercialized by ADAMA, an emulsifiable concentrate comprising 10% w/w bifenthrin) in its effectiveness against Nezara viridula.

Vessels containing superficially sterilized green beans and moist cotton were prepared prior to the work solutions.

The work solutions were then prepared in clean tubes, mixing distilled water and each assayed product in the necessary amounts to generate intended treatments as described in Table 13 below.

TABLE 13
Bifenthrin treatments used to ascertain
effectiveness against Nezara viridula

| | | Bifenthrin | |
|---|---|---|---|
| Treatment | Product | concentration | Dose |
| number | assayed | (g/l or kg) | (g bifenthrin/ha) |
| 1 | Composition 2 | 250 | 20 |
| 2 | | 250 | 16 |
| 3 | | 250 | 12 |
| 4 | | 250 | 8 |
| 5 | | 250 | 6 |
| 6 | | 250 | 2 |
| 7 | | 250 | 1 |
| 1 | Seizer | 100 | 20 |
| 2 | | 100 | 16 |
| 3 | | 100 | 12 |
| 4 | | 100 | 8 |
| 5 | | 100 | 6 |
| 6 | | 100 | 2 |
| 7 | | 100 | 1 |

Nymphs in stage N4/N5 were selected and a drop (2 μl) of each treatment was applied on the dorsal section of each individual for a total of 16 nymphs per treatment and repetition. While the application was carried out, the nymphs were released in the previously prepared vessels. 5 repetitions were carried out for each treatment.

After the application, the vessels were kept in controlled temperature and humidity conditions. Evaluations were made at 24, 48, 72 and 96 hours after the application, recording at each instance the mortality rate, counting the number of alive, dead and dying individuals.

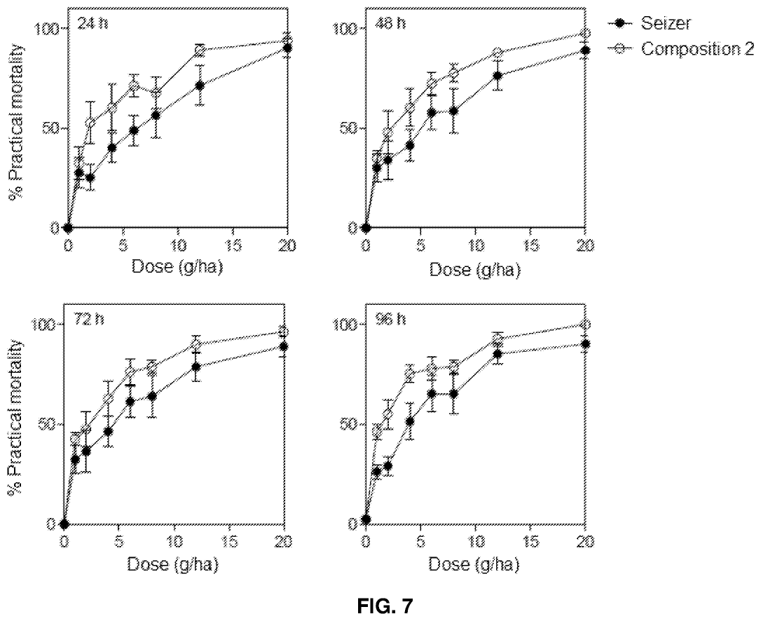

The data thus obtained were processed and the LD50, LD90, LD95 and LD99 for each product were estimated by means of the analysis of dose-response curves (FIG. 7). The results are shown below in Table 14.

The design of this protocol was based on IRAC 029 for susceptibility assessment.

TABLE 14
LD results for effectiveness against Nezara viridula
Average ± SE

| | Seizer | Composition 2 | % Red |
|---|---|---|---|
| LD50 | 3.5 ± 0.5 | 1.6 ± 0.2 | 47.11 |
| LD90 | 23.1 ± 6.9 | 11.4 ± 2.1 | 49.26 |
| LD95 | 39.4 ± 15.9 | 19.6 ± 5.0 | 49.88 |
| LD99 | 107.3 ± 70.2 | 54.8 ± 23.0 | 51.08 |

### Example 8—Stability Assays

Composition 2 as described in Example 1, Composition 6 as described in Example 3, a commercial formulation corresponding to a 10% bifenthrin suspendable concentrate (Bifentrin Nova®, Nova) and a second commercial formulation comprising both bifenthrin and thiamethoxam (Talante Plus®, Rotam) as active ingredients.

Each formulation was diluted in 1000 ppm standard water (5 ml in 100 ml) to form an emulsion or a suspension, depending on the product. The stability of said emulsions/suspensions was assessed in term of free amounts of “oil” or “cream” separated, or solids precipitated, while each emulsion/suspension is left to rest undisturbed for 30 minutes, 2 hours and 24 hours in a thermal bath as 30° C.

### Initial Dilution:

100 ml cylinders were filled with 95 ml of standard water at (30±1° C.), and 5 ml of each formulation at the same temperature are poured gently on the water surface. The cylinders were then covered and inverted once.

### Emulsion/Suspension in Stability:

The cylinders were inverted 10 times and allowed to rest undisturbed at constant temperature of (30±1° C.) in a bath for 24 hours. At 30 minutes, 2 hours and 24 hours, the cylinders were observed, and if any free oil, foam, cream or precipitate was noted, the volume was registered.

The results are shown below in Table 15.

TABLE 15
Emulsion stability results

| Formulation | 0 min | 30 min | 2 h | 24 h |
|---|---|---|---|---|
| Composition 6 | No evidence of | No evidence of | No evidence of | No evidence of |
| | microemulsion | microemulsion | microemulsion | microemulsion |
| | breakdown or | breakdown or | breakdown or | breakdown or |
| | precipitates is | precipitates is | precipitates is | precipitates is |
| | observed | observed | observed | observed |
| Thiamethoxam + | No separation is | Precipitate is | Increase in | Increase in |
| bifenthrin commercial | observed | observed | precipitate | precipitate |
| formulation | | (approx. 0.5%) | amount | amount |
| | | | (approx. 1%) | (approx.4%) |
| Composition 2 | No evidence of | No evidence of | No evidence of | No evidence of |
| | microemulsion | microemulsion | microemulsion | microemulsion |
| | breakdown or | breakdown or | breakdown or | breakdown or |
| | precipitates is | precipitates is | precipitates is | precipitates is |
| | observed | observed | observed | observed |
| Bifenthrin commercial | A small amount | Clear amount | Increase in | Increase in |
| formulation | of precipitate is | of precipitate is | precipitate | precipitate |
| | observed | observed | amount | amount (approx. |
| | | (approx. 1%) | (approx. 1.5%) | 2%) |

The commercial products exhibit a lacking stability. This could result in a gradient-like aspersion, where in the beginning of the application the broth would have a higher concentration of active ingredient(s) dispersed therein, and as the application proceeds the concentration would decrease due to the precipitation of the active ingredient(s). This would generate a decrease in the efficacy of the formulation as the aspersion proceeds. The formulations according to the present invention, in contrast, remain unchanged in time, thus allowing for a homogeneous application throughout the aspersion of the whole broth.

### Example 9—In Vitro Effectiveness of a Bifenthrin+Thiamethoxam Composition According to the Invention in the Control of Nezara viridula

### Experimental Design

For each treatment 4 repetitions corresponding to an experimental unit will be prepared. The assay will be performed with 2 growth stages: nymphs (N4/N5) and adults.

The vessels will be kept in a controlled environment.

### Assessments:

LD50-Three assessments will be made, at 24 h, 48 h and 72 h after application. The assessments will consist of the count of alive, dead and dying individuals.
Data analysis—An analysis of variance corresponding to the experimental design used, with a significance level of 0.05 (α).

TABLE 16
Bifenthrin + thiamethoxam treatments used
to ascertain effectiveness against Nezara viridula

| | | Active ingredients | | | |
|---|---|---|---|---|---|
| | | concentration (g/l or kg) | | Dose (g/ha) | |
| Treat. No | Formulation | Thiamethoxam | Bifenthrin | Thiamethoxam | Bifenthrin |
| 1 | Composition 6 | 50 | 25 | 50 | 25 |
| 2 | | 50 | 25 | 40 | 20 |
| 3 | | 50 | 25 | 31.5 | 15.75 |
| 4 | | 50 | 25 | 23.25 | 11.625 |
| 5 | | 50 | 25 | 15 | 7.5 |
| 6 | | 50 | 25 | 6.5 | 3.25 |
| 7 | Talante Plus | 234 | 166 | 35.1 | 24.9 |
| 8 | | 234 | 166 | 28.08 | 19.9 |
| 9 | | 234 | 166 | 22.23 | 15.8 |
| 10 | | 234 | 166 | 16.38 | 11.6 |
| 11 | | 234 | 166 | 10.53 | 7.5 |
| 12 | | 234 | 166 | 4.68 | 3.3 |

1. An agricultural composition comprising bifenthrin, cyclohexanone, calcium phenyl sulfonate, castor oil ethoxylate, tristyrylphenol ethoxylate, fatty acid methyl esters (FAME), a polyalkylene oxide block copolymer, and water.

2. The agricultural composition of claim 1, wherein the polyalkylene oxide block copolymer is an ethylene oxide/propylene oxide (EO/PO) block copolymer.

3. The agricultural composition of claim 1, wherein the composition comprises bifenthrin in a concentration from 20% to 30% w/v.

4. (canceled)

5. (canceled)

6. The agricultural composition of claim 1, wherein the composition comprises cyclohexanone in a concentration from 30% to 35% w/v.

7. (canceled)

8. The agricultural composition of claim 1, wherein the composition comprises FAME in a concentration from 1.5% to 2.5% w/v.

9. (canceled)

10. (canceled)

11. The agricultural composition of claim 1, wherein the composition comprises calcium phenyl sulfonate (70% w/w) in a concentration from 9.5% to 10.5% w/v.

12. (canceled)

13. The agricultural composition of claim 2, wherein the composition comprises the EO/PO block copolymer in a concentration from 9% to 11% w/v.

14. (canceled)

15. (canceled)

16. The agricultural composition of claim 1, wherein the composition comprises castor oil ethoxylate in a concentration from 9% to 11% w/v.

17. (canceled)

18. (canceled)

19. The agricultural composition of claim 1, wherein the composition comprises tristyrylphenol ethoxylate in a concentration from 4.5% to 5.5% w/v.

20. (canceled)

21. (canceled)

22. The agricultural composition of claim 1, wherein the composition further comprises epoxidized soybean oil in a concentration from 0.9 to 1.1% w/v.

23. (canceled)

24. (canceled)

25. The agricultural composition of claim 1, wherein the composition further comprises at least one additional insecticidal active ingredient.

26. The agricultural composition of claim 25, wherein the at least one additional insecticidal active ingredient comprises acetamiprid.

27. The agricultural composition of claim 26, wherein the at least one additional insecticidal active ingredient comprises acetamiprid and chlorpyrifos.

28. An agricultural composition comprising bifenthrin, thiamethoxam, cyclohexanone, calcium phenyl sulfonate, castor oil ethoxylate, a polyalkylene oxide block copolymer, tristyrylphenol ethoxylate and water.

29. The agricultural composition of claim 28, wherein the composition further comprises dimethyl sulfoxide (DMSO).

30. The agricultural composition of claim 28, wherein the composition further comprises epoxidized soybean oil.

31. The agricultural composition of claim 28, wherein the composition further comprises ethanol.

32. The agricultural composition of claim 28, wherein the composition further comprises iso-tridecyl alcohol polyglycol ether.

33. (canceled)

34. A method for controlling an insect plague in a crop, the method comprising applying an effective amount of an agricultural composition according to claim 1.

35. (canceled)

36. A method for controlling an insect plague in a crop, the method comprising applying an effective amount of an agricultural composition according to claim 28.
